(19) United States
(12) Patent Application Publication
(10) Pub. No.: US 2021/0263644 A1
(43) Pub. Date: Aug. 26, 2021

(54) MULTIPAGE DISPLAY ON A COMPUTING DEVICE

(71) Applicant: Swiftclass SA, Geneva (CH)

(72) Inventor: Steven Peter Robinson, Hampshire (GB)

(73) Assignee: Swiftclass SA, Geneva (CH)

(21) Appl. No.: 17/252,271

(22) PCT Filed: Jun. 10, 2019
(86) PCT No.: PCT/EP2019/065060

§ 371 Date: Dec. 15, 2020

(30) Foreign Application Priority Data
Jun. 15, 2018 (GB) 1809810.3

(51) Int. Cl. G06F 3/0488; G06F 3/0483; G06F 3/0482; G06F 3/0484

(52) U.S. Cl. CPC G06F 3/04886; G06F 3/0483; G06F 2203/04808; G06F 3/04845; G06F 2203/04803; G06F 3/0482

(57) ABSTRACT

A method of simultaneously displaying a plurality of user interface pages on a display screen of a computing device includes generating a render tree comprising a plurality of objects each having one or more layout parameters, the plurality of objects including a plurality of page objects each having one or more child objects. A launcher application is first attached to a first container and then a list object is attached to the first container, the list object comprising a plurality of page containers to which the page objects are attached. The render tree is traversed to recursively attach the one or more child objects to respective page containers. In response to user input the list object is transformed to a grid object, the grid object comprising transformed page containers having transformed layout parameters, the transformed layout parameters being generated from layout parameters of the page objects in accordance with a grid layout. The grid object is then displayed on the display screen of the computing device according to the transformed layout parameters.

### BACKGROUND

The present invention relates to user interfaces for computing devices, such as smartphones and other mobile devices, and in particular, rendering of graphics in the implementation of a user interface.

The number of new applications, or apps, being developed for mobile devices is on the rise, providing users with increasing functionality on their mobile device.

At the same time, the complexity and functionality of user interfaces continues to increase, thus placing greater demands on the graphics hardware of mobile devices, and making it more challenging to provide a good user experience when switching between different apps or groups of apps.

A particular challenge which arises in relation to complex UI elements (e.g., large numbers of application icons and/or animation effects) rendered on devices with limited graphics hardware capability is in maintaining a smooth transition between different display states. In conventional UI rendering, such as that implemented in Android® based devices using the standard rendering pipeline, each image surface requires a graphics buffer having a size (in pixels) which is a power of 2. For every image render, several functions are called, so displaying 100 images on screen would require several hundred function calls every frame. This limits the ability of the device to display the UI at high enough frame rates to appear smooth to the human eye.

It would be desirable to alleviate one or more of the above difficulties, or at least to provide a useful alternative.

### SUMMARY

According to an aspect of the present invention there is provided a method of simultaneously displaying a plurality of user interface pages on a display screen of a computing device, the method comprising: generating a render tree comprising a plurality of objects each having one or more layout parameters, the plurality of objects including a plurality of page objects each having one or more child objects; attaching a launcher application to a first container; attaching a list object to the first container, the list object comprising a plurality of page containers to which the page objects are attached; traversing the render tree to recursively attach the one or more child objects to respective page containers; responsive to user input, transforming the list object to a grid object, the grid object comprising transformed page containers having transformed layout parameters, the transformed layout parameters being generated from layout parameters of the page objects in accordance with a grid layout; and displaying the grid object on the display screen of the computing device according to the transformed layout parameters.

The present invention therefore provides a multipage display functionality executable by a computing device. Advantageously, the multipage feature allows a user to view multiple pages of icons or widgets on a display screen of the computing device simultaneously. This avoids the need to scroll through multiple pages to view the icons and widgets on each page. Instead, the user will be able to view, and interact with, multiple icons and widgets at the same time. The user experience is therefore improved as fewer interactions with the user interface are required in order to access desired content and/or functionality. In addition, power consumption may be reduced since the computing device is required to process fewer user input gestures.

Each page container may have at least one widget and/or application attached thereto. Applications, or apps, may be launched from any page being displayed in the multipage display through user interaction. App icons and widgets may be dragged from any page onto any other page.

Each child object may be associated with only one parent container. Each parent container may have multiple child containers. This provides a nested tree structure with a main parent for a main control application, for example a launcher application.

The user input may be received via a touch screen interface. The user input may be a pinch or swipe motion. Thus, simple motions which can be carried out by any user may trigger the multiple pages to be displayed on the same physical screen. This ensures the multipage feature is intuitive and easy to use.

The layout parameters may include at least one of the following: position, size, font, image location, opacity, scale, and rotation. Any other suitable layout parameters may also be included.

According to another aspect of the present invention there is provided a computing device comprising a processor configured to perform the previously described method.

According to another aspect of the present invention there is provided a computer-readable storage medium comprising instructions which, when executed by a computer, cause the computer to carry out the previously described method.

### BRIEF DESCRIPTION OF THE DRAWINGS

Embodiments of the invention will now be described, by way of non-limiting example only, with reference to the accompanying drawings, in which:

FIG. 1 shows the architecture of an example computing device configured to execute a rendering process according to certain embodiments;

FIG. 2 shows a hardware component of the computing device of FIG. 1;

FIG. 3 is an example of a screen layout rendered on the computing device of FIG. 1;

FIG. 4 is a render tree which can be used to produce the screen layout of FIG. 3;

FIGS. 5A and 5B show a flowchart of an embodiment of a rendering process;

FIG. 6 is a flowchart of an example image loading process;

FIG. 7 is a flowchart of an example image decompression process;

FIG. 8 is a flowchart of an example image conversion process; and

FIG. 9 illustrates the addition of an image to an image scratchpad according to certain embodiments.

### DETAILED DESCRIPTION

Embodiments of the present invention relate to a rendering engine which may be utilised by web browsers, launchers and other applications executable by computing devices. The rendering engine greatly improves the graphics performance of such devices, especially in cases where the native graphics capability of the device hardware and/or operating system is limited. The present inventors have found that it is possible to achieve frame rates of up to 160 fps on a Huawei P9 Lite device running Android 6.0, for example, using techniques substantially in line with those described herein.

Other embodiments relate to a multipage display functionality embodied in a launcher application executable by a computing device. The multipage feature allows a user to view multiple pages of icons or widgets on a display screen of the computing device simultaneously.

A widget (or mobile widget), as referred to herein, may be an application extension which is associated with an application installed on the computing device, and which displays data stored by or retrievable by the associated application without opening it. For example, a calendar widget may display upcoming events stored in a database of a calendar application, without opening the calendar application itself.

In some embodiments, applications, or apps, can be launched from any page being displayed in the multipage display through user interaction. In addition, in at least some embodiments, app icons and widgets can be dragged from any page onto any other page. To achieve the multipage display, each page may be transformed from a list object to a grid object using, for example, a pinch or swipe motion.

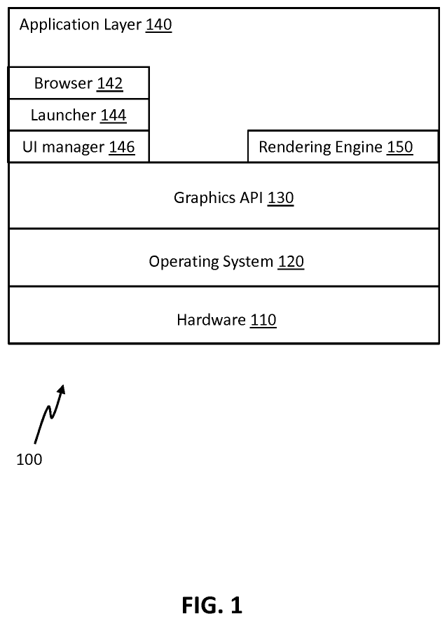

Referring now to FIG. 1, a computing device 100 suitable for implementing certain embodiments of the present invention is shown. The computing device 100 may be a mobile computing device such as a smartphone or tablet, or may be another type of computing device such as a laptop, set-top box, in-flight entertainment unit, in-vehicle display, and the like. The architecture of computing device 100 comprises a hardware component 110, an operating system 120, a graphics API 130, and an application layer 140, which may comprise applications such as a web browser 142, and a launcher application 144 which may cooperate with rendering engine 150 in order to render text or graphics of a user interface of the computing device 100, under the control of a UI manager component 146. The graphics API 130 may be any suitable graphics API, such as OpenGL (or OpenGL ES), WebGL, or DirectFB. Operating system 120 may be, for example, Android, iOS, Linux, Microsoft Windows, etc.

The UI manager component 146 may be written in any suitable language, such as C++ or Java. In some implementations, as described below, it will be convenient for the UI manager component 146 to be implemented in Javascript, together with a suitable Javascript engine such as SpiderMonkey, JavaScriptCore, V8 of Google, Inc, or Duktape.

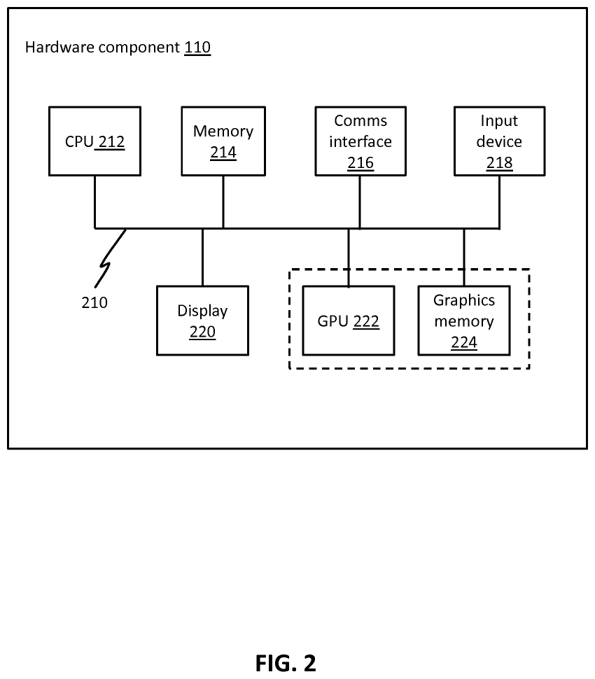

As shown in FIG. 2, an example hardware component 110 comprises at least one processor (CPU) 212, at least one memory unit 214 (which comprises at least volatile storage (RAM) and preferably also non-volatile storage such as magnetic disk or solid state storage), at least one communications interface 216, and at least one input device 218, such as a keyboard, button panel, mouse, stylus, touchpad, and the like. The hardware component also comprises display 220, at least one graphics processing unit (GPU) 222, and a graphics memory unit 224 which is in communication with GPU 222. A bus 210 may interconnect each of these sub-components of hardware component 110. In some embodiments, display 220 may be a touch screen display, in which case it is capable (in addition to input device 218, if present) of accepting user input. Communications interface 216 generally acts to receive data at, and transmit data from, the computing device 100, and may comprise one or more of a Bluetooth, WiFi, NFC, USB or Ethernet interface.

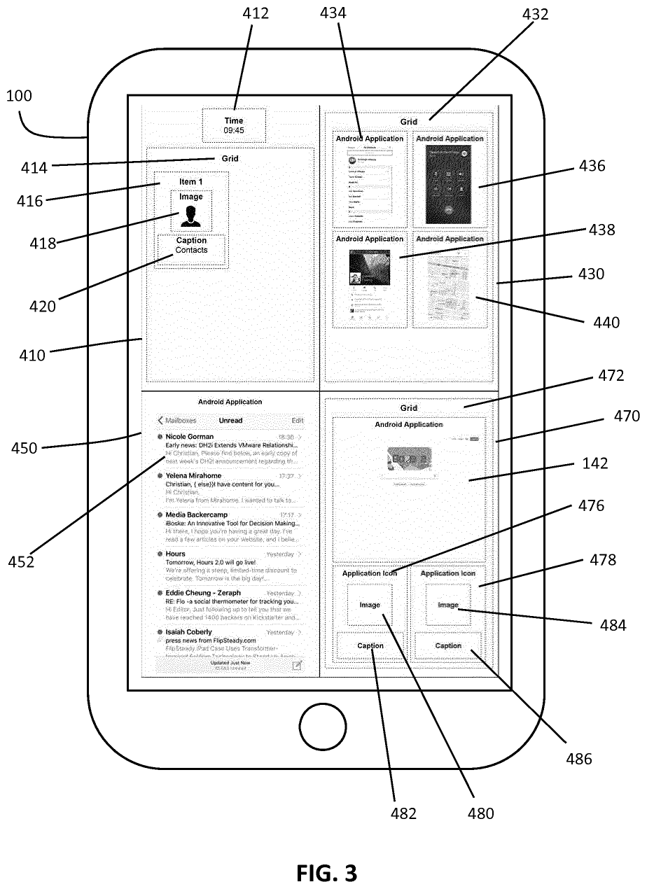

Turning to FIG. 3, a computing device 100 displays various graphical and text elements which represent applications and other items such as widgets. At least some of these elements may be interacted with by a user, for example via a touch screen 220 of the computing device 100. In addition, the UI manager component 146 executing on the computing device 100 may enable functionality to display multiple pages of applications and widgets, which can be navigated by the user swiping across the screen 220, for example. In some embodiments, a user interface interaction (such as a user swiping upwards on the touch screen 220) may trigger the multiple pages to be displayed on the same physical screen, as depicted in FIG. 3. This functionality may be enabled by a launcher application 144 which has overall control of the manner in which icons and text are laid out on the screen, and animation effects which are visible to the user as they interact with the device 100. The launcher application 144 may utilise a rendering engine 150, separate from native rendering functionality of the operating system 120 and graphics API 130, as will later be described in more detail.

Multipage Display

The UI manager component 146 of mobile device 100 executes a launcher app 144. The launcher 144 is an app that enables user access to various functions and features of the mobile device 100, including access to the home screen, the app “grid”, widgets, and launching of other apps.

The launcher app 144 provides user access to multiple virtual pages, any one of which, or more than one of which, may be visible on display 220 at any given time dependent on user interaction with the display 220. The virtual pages may include, as a default (i.e. a first page visible to a user on powering on the device 100), a home screen. The launcher 144 may enable pages to be accessed to the left and/or the right of the home screen page by, for example, the user swiping right or left on the display 220. The launcher 144 may enable the user to customise the total number of pages by adding or removing pages on the left and/or right of the home screen page. Each page may be associated with a number of icons, app shortcuts, and widgets which allow the user to interact with the mobile device in a variety of different ways. The user can access all the pages by swiping left or right and cycling through the list of available pages. This allows the user to view the app shortcuts and widgets that are associated with each page, and displayed within the page when it is rendered to display 220.

The multipage display functionality of embodiments of the present invention allows the user to view multiple pages at the same time on the main home screen page. This avoids the need to scroll left and right between the different pages to access the content of each page. Accordingly, the user experience is improved since fewer interactions with the user interface are required in order to access desired content and/or functionality. Additionally, power consumption may be reduced since the CPU 212 of mobile device 100 is required to process fewer user input gestures.

In order to enable multipage functionality, the UI manager component 146 attaches each object of the user interface (including text, images, applications, icons, and widgets) to a container prior to rendering, in accordance with a render tree which specifies the desired screen layout. Each container has a number of layout attributes associated with it that are passed to the rendering pipeline (e.g., via rendering engine 150) in order to enable display of the user interface elements. Attributes may include position (top/bottom, left/right), size (width and height), font (size, colour, font family), image (location, default image), and appearance (opacity, scale, rotation).

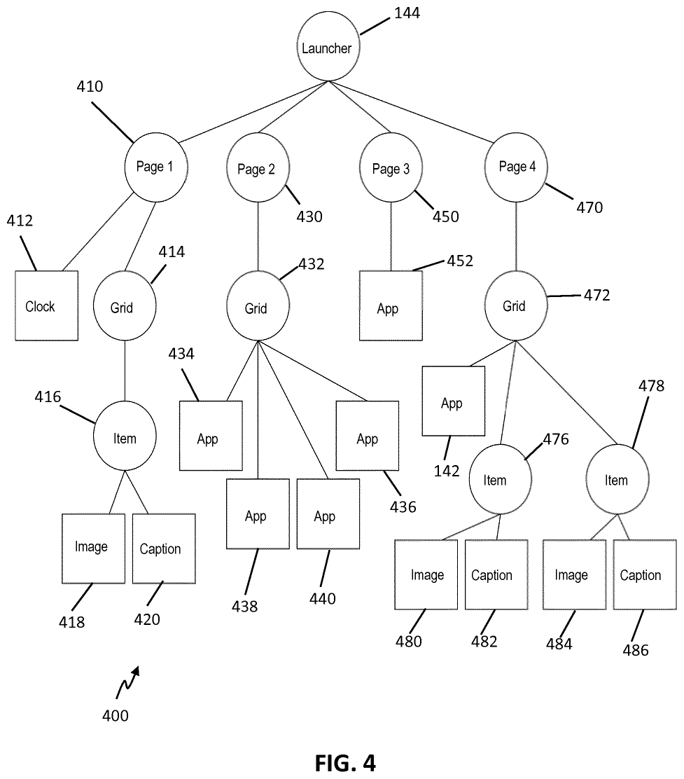

FIG. 3 shows an example of a multipage display on a mobile device 100. The tree structure corresponding to the multipage display of FIG. 3 is illustrated in FIG. 4. Tree structure 400 defines the desired layout of images, text, applications, and widgets on the display 220, and may be modified during execution of the launcher application 144, for example by user modification of preference data for the launcher application 144, or automatically during display of an animation effect.

As shown in FIG. 3, four pages 410, 430, 450, 470 are rendered to the display 220. A first page 410 may display a clock widget 412 and a grid 414 having a shortcut 416 to a contacts application 418 with corresponding caption 420, a second page 430 may display a grid 432 of executing applications 434, 436, 438, 440, a third page 450 may display a single executing application such as a mail application 452, and a fourth page 470 may display an executing browser application 142 in one part of the page 470 and application icons 476, 478 in another part of the page 470. A user may switch between the multi-page grid view of FIG. 3 and a single-page view (not shown), in which any one of pages 410, 430, 450, 470 is displayed individually on display 220, via a predetermined user input gesture such as a vertical swipe or pinch.

In order to generate the screen layout as shown in FIG. 3, custom user interface module 146 executing on processor 212 traverses the render tree 400 of FIG. 4, and starts by creating a container instance to which launcher app 144 is attached. The custom user interface module 146 may be written in JavaScript (though it will be understood that non-Javascript implementations are also possible, as discussed above), and is responsible for the creation and destruction of containers including the container for the launcher 144.

At the next level of the tree 400, each page 410, 430, 450, 470 is attached to its own respective container, each of which is attached to the root container 144 as a child. The container for launcher app 144 may contain a list object comprising the four page containers. Each child container only has one parent container associated with it but each parent container can have multiple child containers, as shown in FIG. 4. The containers therefore have a nested structure with a main parent or root container for launcher app 144, with each successive parent being attached to a container at a higher level in the tree structure. It will be understood, therefore, that each node of the render tree 400 corresponds to a container. In the discussion that follows, and in FIGS. 3 and 4, UI objects and their corresponding containers will be referred to by the same reference numeral (e.g., image object 418 in FIG. 3 corresponds to node 418 in FIG. 4).

For example, the clock widget container 412 is attached to the first page container 410 as a child, and the first page container 410 is itself attached to the launcher app container 144 as a child. The clock widget container 412 is the first child of the first page container 410. A grid container 414 for app shortcut container 416 attached to the first page container 410 is the second child of the first page container 410. Text and images associated with the app shortcut container 416 form leaf nodes 418, 420 of the tree structure.

Each page 410, 430, 450, 470 may contain at least one widget and/or app shortcut. Each page container may therefore have at least one child widget and/or app shortcut container associated with it.

As mentioned above, the page containers 410, 430, 450, 470 may initially be attached to a list object, which is itself a container. The list may be implemented as a widget which is scrollable sideways. The list allows the user to scroll through the available pages and select one for current viewing. The list can be thought of as a horizontal container of page containers 410, 430, 450, 470.

Each element (widget, icon, app shortcut) within a page is held within (i.e., attached to) its own container. For example, the clock widget 412 will be held in a separate container to a container such as 416 which has an image or text information.

In order to change views from a single page view to a multiple page view, the user may perform a pinch movement or other gesture on the display 220. This movement reconfigures the horizontal list container into a grid container. UI manager component 146 detects the pinch movement or other gesture, accesses the list object of the launcher app container 144 which holds the individual page containers, and transforms the list object to a grid object dependent on the number of items in the list, generating layout attributes for the grid object accordingly.

The dimensions of the grid container may be determined by the number of page containers held within the list container. For example, a list container holding three or four page containers may be transformed to a 2×2 grid container by default (though other grid layouts are possible, for example 1×3 or 3×1 for three pages, depending on the screen orientation and user preferences). All home screen pages can therefore be viewed, and interacted with, simultaneously on the display screen of the mobile device 100. The grid layout can also be selected to display a subset, rather than all, of the pages in the list container. For example, if the list container holds eight page containers, the UI manager component 146 may generate, from the list container, a transformed list container which contains two grid containers, each of which contains four page containers and has a 2×2 layout. The transformed list container can thus be used by UI manager 146 to allow the user to scroll between the two 2×2 grids of pages. UI manager 146 may also enable user input to determine the layouts of individual grids; for example, a first grid in the list may have a 2×2 layout, while a second grid has a 2×1 layout and a third grid has a 1×2 layout.

The grid container may automatically determine the optimum layout and size of the child page containers, based on the number of page containers and/or the number of objects in each page container, and scale the pages accordingly. For example, when viewing two pages on a single screen, the UI manager 146 may automatically configure each page at 50% of its original height or width. In some embodiments, the UI manager 146 may allow the user to select relative sizes of the pages in a grid (e.g., a first page being sized to occupy a third of the screen height, and a second page being sized to occupy the remaining two thirds of the screen height). The children of each page container may also be scaled accordingly. For example, when switching from a single-page view of page 410 to the 2×2 multipage view shown in FIG. 3, UI manager 146 may traverse the render tree 400 starting at node 410 and automatically transform the layout parameters of each child container 412, 414, 416, 418, 420 such that each component is scaled to half its original size.

It is possible to have grids that are 3×3, 3×2, 4×4, or any general n×m grid (where n and m are integers) depending on the size and resolution of the device screen.

Every time a new container is created for an object, two data structures may be generated. The first data structure is the JavaScript virtual machine context for the object (such as application, widget, image or text) exposed to the JavaScript scripting of UI manager 146. The second data structure is a C data structure that holds the rendering information for the container, including layout parameters, colour information, image information and text information, and which is passed to the rendering engine 150 and/or to low-level graphics functions of the operating system 120 via graphics API 130. The two data structures enable the UI manager 146 to communicate with the rendering engine 150, and vice versa, in order to cause objects to be rendered to display 220. Of course, if the UI manager 146 and rendering engine 150 are both written in C (for example), this mechanism is unnecessary for the two components to communicate with each other.

The two data structures are linked while the container exists. That is, the data structures are linked at the time the container is created, and are delinked only when the container is destroyed. In order to link the two data structures, the C data structure includes a pointer which is set to the JavaScript virtual machine object context. A JavaScript virtual machine function may then be called to attach the C data structure to the JavaScript virtual machine object, such that when a function is called on the JavaScript virtual machine object, this in turn results in a call of the corresponding C function.

To create a container, memory is first allocated for a container pointer. Once memory has successfully been allocated, the pointer is initialised and the container is created.

Once a container has been created, a first container can be attached to a second container using a container attachment process. That is, a second, child container can be attached to a first, parent container. In order to attach a child container to a parent container, both the child container and parent container need to be created initially using the container generation process described above. To attach the second container to the first container, it is first checked whether two valid containers exist and whether either container already has a child container attached. As each child container can only have one parent container, if it is found that a child container is already attached to a parent container, the child container is detached from the current parent, and then attached to the new parent. In embodiments where linked data structures are required as described above, the container attachment process may involve adding a pointer to the C structure in the JavaScript object, and adding a pointer to the JavaScript object in the C structure.

A garbage collection process can then be run which automatically manages the memory of the computing device 100. During the garbage collection process, a garbage collector reclaims memory that is occupied by objects that are no longer in use. The garbage collection process may be carried out on both the JavaScript and C data structures to ensure that corresponding data structures are destroyed together. That is, the garbage collection process ensures that when a particular C data structure is freed up the corresponding JavaScript data structure is also freed up, and vice versa. This makes sure that no memory leaks or zombie pointers occur.

The container may include (for example, in its C data structure) data relating to the tree structure of which the container forms a part. For example, the tree-related data may include a pointer to a parent container, a pointer to a previous sibling container, a pointer to a next sibling, a first child pointer, and a last child pointer.

Each container may also comprise x and y coordinates, a height, and a width. This information is used to determine the position, size, and orientation of each container being generated. Thus, position, size, and orientation information within the data structure is used to define the way in which the object attached to the created container will be displayed. The values stored may include top, left, width, height, angle, alignment, wrap, and clip. Other container attributes may include text and font information such as font family, font size, font handle, caption (i.e., the characters to be displayed), and output handle.

Each container may also include image-related information, such as a file path or URL, and a handle. The image file paths or handles, along with animation handles, and virtual machine object handles are contained within the C data structure. Colour information is also stored, which includes red, green, and blue values as well as opacity.

As mentioned before, the multiple pages may be configured as a horizontal list which a user can scroll through to view the additional pages. The JavaScript widget for lists when configured as a horizontal list and with each item configured as 100% would show one page at a time on the display on the mobile device. The user then swipes left or right to view the previous or next page in the horizontal list of pages.

The JavaScript widget for a grid list when configured as a horizontal grid list and with each item configured as 50% may show four pages at a time on the display screen. In this case, the user is able to navigate left and right between grids of four pages at a time.

Attaching the launcher app container 144 to either of the above mentioned widgets, i.e. the horizontal list or the grid list, may automatically trigger the corresponding JavaScript widget to configure each child container with the positions and dimensions that have been defined for it.

Rendering Process

A single-page or multipage display as described above may be rendered using the standard rendering pipeline of operating system 120. In some embodiments, a custom rendering process may be employed, and an example of such a rendering process will now be described in detail. It will be appreciated that the rendering process described below is suitable not just for mobile devices such as mobile device 100, but is also suitable for devices such as laptops, set-top boxes, in-flight entertainment units, and in-vehicle displays.

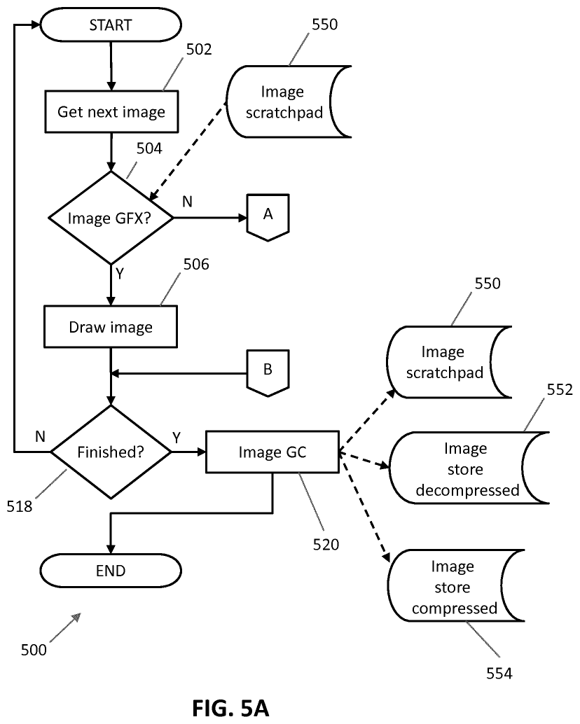

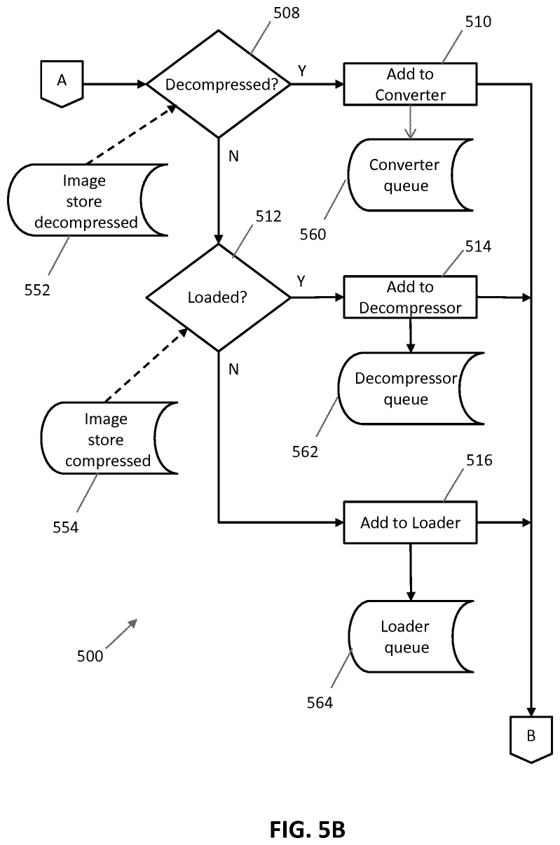

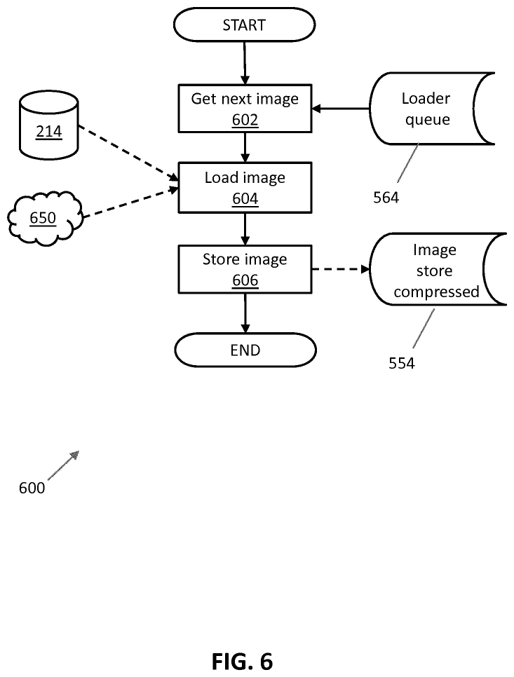

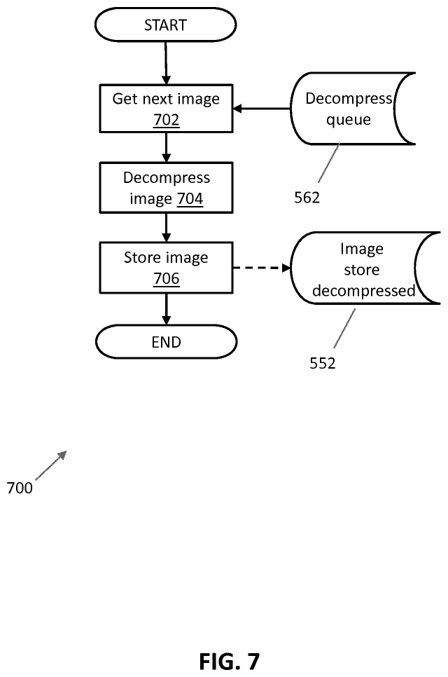

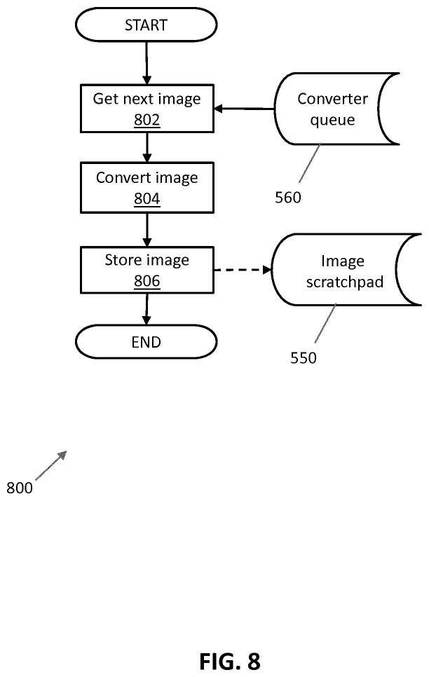

Referring now to FIGS. 5A and 5B, a rendering process 500 of rendering engine 150 is shown. In this embodiment, rendering engine 150 executes a multithreaded process including the rendering process 500, an image loader process 600 (FIG. 6), a decompression process 700 (FIG. 7) and an image conversion process 800 (FIG. 8), that is, one or more instances of each of the processes 500, 600, 700, 800 may be executed concurrently. For example, a number of image loaders, decompressors and converters can be configured to run on separate threads according to the hardware capabilities of the computing device 100 (e.g., the amount of available graphics memory 224). It will be understood that in some embodiments, one or more of these processes can be executed sequentially rather than concurrently.

The rendering process 500 takes, as input, a render tree such as the render tree 400 in FIG. 4, and traverses the render tree to determine which image objects are to be displayed on display 220 of computing device 100. Each image object in the render tree typically comprises a path, x and y coordinates indicating the top left hand corner in the display coordinate space, a height, a width, and a status indicator. The status indicator provides an indication as to the current status of the image object. For example, a status code of “busy” indicates that the image object is currently being processed elsewhere, e.g. by another thread.

More specifically, the status code may indicate exactly which part of the rendering pipeline the image object has reached, and possible status codes may include “dormant”, “loading”, “loaded”, “decompressing”, “decompressed”, “converting”, “converted”, or “failed” (or numerical codes which map to these human-readable status codes).

In embodiments which employ the nested container approach discussed above, each image object may be attached to a container, and each image container may accordingly include the additional attributes mentioned above.

Each image object may also comprise a timestamp indicating when it was last rendered to display 220, and a counter indicating how often it has been rendered. This information may be used for garbage collection purposes as mentioned in further detail below.

Additionally, each image object comprises a pointer to an image scratchpad. An image scratchpad, as used herein, is a large canvas or bitmap buffer which has rendered into it a plurality of images and is held in graphics RAM (e.g. graphics memory 224). Individual components of the image scratchpad may be selectively composed into a bitmap which is written to a display buffer to be displayed on the display of a computing device (e.g., device 100). An image scratchpad may also be referred to herein as a sprite map. The image data may be generated from, for example, raster formats such as PNG or JPG, or may be generated from text objects, such as by generating rasterised representations of glyphs in a particular font. The image scratchpad may be generated at runtime and may initially, for example, comprise a plurality of standard image elements, including glyphs for one or more fonts at one or more font sizes. The image scratchpad may then be modified by the rendering engine 150 as new image elements are encountered.

Advantageously, the use of an image scratchpad decreases memory requirements for the storage of graphics objects to be rendered to the display. The scratchpad also improves processing speed since all of the rendering can be placed into a large array and then a single call to render is done instead of multiple rendering calls corresponding to individual image elements.

The buffer allocated for the image scratchpad may be of a size up to a limit allowed by the graphics API 130. For example, the buffer size limit for OpenGL ES is 2048×2048.

At step 502, rendering process 500 retrieves data relating to the next image object from the render tree, and determines, at step 504, if the image is already in in a form suitable for writing directly to graphics memory 224, by checking that the status code of the image is “converted”. If so, the image can be retrieved from the image scratchpad 550 referenced by the image object, and drawn to the display 220 using an appropriate graphics API call, at step 506. For example, the following OpenGL ES calls may be used to set the position, set the texture, and then draw an image:
glVertexAttribPointer (p_prog->positionLoc, 3, GL_FLOAT, GL_FALSE, 5 * sizeof(GLfloat), vVertices_img);
glVertexAttribPointer (p_prog->texCoordLoc, 2, GL_FLOAT, GL_FALSE, 5 * sizeof(GLfloat), &vVertices_img[3]);
glDrawElements (GL_TRIANGLES, 6, GL_UNSIGNED_SHORT, indices);

Here, p_prog is a pointer to a vertex shader, and vVertices_img holds the positions of the image components in the image scratchpad 550. Any suitable vertex shader may be used, though it will be appreciated that different vertex shaders may be used that are optimised in accordance with the characteristics (e.g. opacity, text) of the object to be rendered.

The rendering process 500 may keep track of which regions of the image scratchpad are occupied, such that new image objects added to the scratchpad do not overwrite existing image objects.

If, at step 504, the process 500 determines that the image object is not already converted, processing proceeds to step 508 (FIG. 5B) and a determination is made as to whether the image data is in compressed or decompressed form, e.g. by checking that the status code of the image is “decompressed”. If it is decompressed, the image data is retrieved from a decompressed image store 552 and a pointer to the image container that holds the decompressed buffer in RGBA format is appended to a converter queue 560 at step 510, and the process goes to step 518 (FIG. 5A).

If the image is not in decompressed form, then it is determined whether or not the image data has been loaded, for example by checking that the status code of the image is “loaded”, at step 512. If so, the compressed image data is retrieved from compressed image store 554 and a pointer to the image container that holds the compressed buffer in PNG or JPEG format is added at step 514 to a decompressor queue 562, and processing goes to step 518.

If the image data has not been loaded, the image object (or more specifically, a path to the image) is added to a loader queue 564, at step 516, and processing goes to step 518 as above.

At step 518, the process 500 determines whether all objects in the render tree have been drawn. If not, it returns to step 502 to retrieve the next image object in the tree, and processing continues as described above. If so, then a garbage collection process 520 may be implemented. The garbage collection process 520 may be triggered at certain thresholds or in particular circumstances, such as when additional RAM and/or graphics RAM is needed for other tasks.

Garbage collection process 520 may determine, for each image object, the timestamp for the last time that the image was rendered and/or the count of the number of times that it has been rendered. A list of images may be generated in which images are ordered according to a plurality of attributes, e.g. first by date created (oldest to newest), then by number of times rendered (least to most), and finally by size (largest to smallest), and the garbage collection process 520 may then progressively clear images from the list from the corresponding area in the image scratchpad 550 in graphics memory 224 until a desired memory threshold is reached. In some embodiments, a subset of the image attributes (e.g. size and number of times rendered, or date created and size) may be used to generate the list for garbage collection.

The graphics processing pipeline for images that are not suitable for directly writing to the graphics memory 224 will now be explained in more detail, with reference to FIGS. 6, 7 and 8. Each of these Figures shows the flow of a thread which processes an image object queue in parallel with the rendering process 500.

In FIG. 6, an image loader process 600 retrieves, at step 602, image object details from loader queue 564, and removes the image from the loader queue 564. Next, at step 604, image loader process 600 determines the path for the image data of the image object, and retrieves the image data, e.g. from local storage 214, or from cloud storage 610. This can be done in any suitable known fashion, such as by an invocation of curl. Finally, the loaded image data is stored in compressed image store 554 and the status of the image is updated to “loaded”. Typically, the loaded and stored image data will be in a format such as PNG.

In FIG. 7, an image decompression process 700 retrieves, at step 702, image data from a decompress queue 562. As mentioned above, images are pushed to the decompress queue 562 when they have been loaded but not decompressed yet. Next, at step 704, the image is decompressed from (for example) PNG format to RGBA format, for example by using one or more libpng library functions to pass in a compressed buffer containing the PNG data, and return an uncompressed RGBA buffer. At step 706, the RGBA data is written to decompressed image store 552 and the image is removed from the decompress queue 562.

In FIG. 8, an image conversion process 800 retrieves, at step 802, an image to be converted from the converter queue 560. At step 804, the image conversion process 800 takes the RGBA data for the image to be converted, and converts this to a format suitable for writing directly to graphics memory 224 (such as ARGB or XRGB), for example by calling one or more OpenGL ES functions to generate a texture of appropriate size, and binding the uncompressed RGBA buffer to the texture. At step 806, the converted data is written to the image scratchpad 550, at a region of the scratchpad 550 that is known to be unoccupied, and the image is removed from the converter queue.

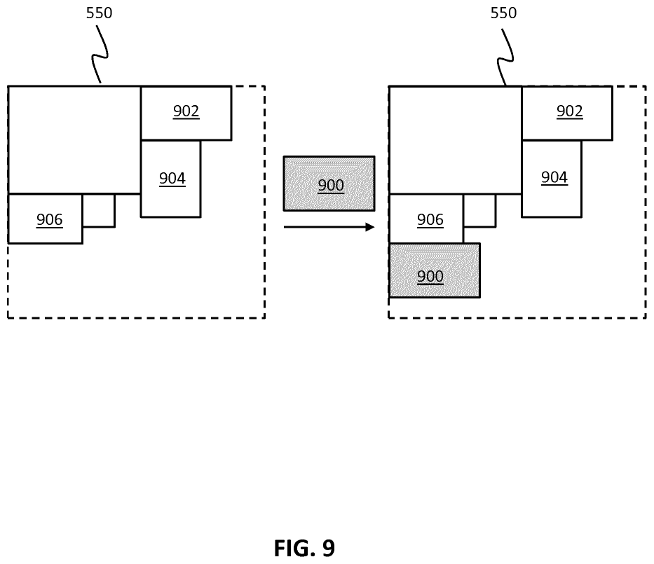

FIG. 9 illustrates a representation of an example image scratchpad 550. In the left panel of FIG. 9, a new image object 900 is being added to a scratchpad which has a plurality of image regions including image regions 902, 904 and 906. In order to fit image object 900 into an unoccupied region of the scratchpad 550, image conversion process 800 (for example) tries to fit the image object 900 to the right of the top-most and left-most occupied region, in this case region 902. Next, because object 900 will not fit to the right of 902, image conversion process 800 tries to fit it to the right of the next occupied region down, namely region 904. This continues until an unoccupied region is found, as shown at the right of FIG. 9.

The image conversion process 800 continues to add image objects as the render process 500 traverses the render tree and the converter queue 560 is processed.

Eventually, it may be the case that an image object that is not already stored in scratchpad 550 is encountered in the render tree, but there is no unoccupied space available in the scratchpad 550 large enough to fit the additional image object. If that occurs, then the scratchpad 550 may be rearranged. To do so, all images (including the previously placed images and the additional image) may first be ordered by width in descending order. Next, each ordered image in the list is placed in the scratchpad by, in turn, attempting to place it to the right of the top-most and left-most occupied region, if that fails trying below the top-most and left-most occupied region, and if that fails then moving to the next image; if all attempts fail then the scratchpad is full. This rearrangement process has been found to be highly efficient in terms of processor usage and usage of the available space in the scratchpad.

Although particular embodiments have been described, it will be appreciated that many variations of the above are possible while still falling within the scope of the invention. For example, although particular implementations in Javascript and C have been discussed, it will be appreciated that the principles employed in the above embodiments are more general and not restricted to any particular programming environment.

1. A method of simultaneously displaying a plurality of user interface pages on a display screen of a computing device, the method comprising:
generating a render tree comprising a plurality of objects each having one or more layout parameters, the plurality of objects including a plurality of page objects each having one or more child objects;
attaching a launcher application to a first container;
attaching a list object to the first container, the list object comprising a plurality of page containers to which the page objects are attached;
traversing the render tree to recursively attach the one or more child objects to respective page containers;
responsive to user input, transforming the list object to a grid object, the grid object comprising transformed page containers having transformed layout parameters, the transformed layout parameters being generated from layout parameters of the page objects in accordance with a grid layout; and
displaying the grid object on the display screen of the computing device according to the transformed layout parameters.

2. The method of claim 1, wherein each page container has at least one of a widget and/or an application attached thereto.

3. The method of claim 2, wherein each child object is associated with only one parent container.

4. The method of claim 1, wherein the user input is received via a touch screen interface.

5. The method of claim 4, wherein the user input is a pinch or swipe motion.

6. The method of claim 1, wherein the layout parameters comprise at least one of: position, size, font, image location, opacity, scale, and rotation.

7. (canceled)

8. (canceled)

9. The method of claim 1, wherein each child object is associated with only one parent container.

10. A non-transitory computer-readable medium having stored thereon instructions that, when executed by a computing device, cause the computing device to perform functions comprising:
generating a render tree comprising a plurality of objects each having one or more layout parameters, the plurality of objects including a plurality of page objects each having one or more child objects;
attaching a launcher application to a first container;
attaching a list object to the first container, the list object comprising a plurality of page containers to which the page objects are attached;
traversing the render tree to recursively attach the one or more child objects to respective page containers;
responsive to user input, transforming the list object to a grid object, the grid object comprising transformed page containers having transformed layout parameters, the transformed layout parameters being generated from layout parameters of the page objects in accordance with a grid layout; and
displaying the grid object on a display screen of the computing device according to the transformed layout parameters.

11. The non-transitory computer readable medium of claim 10, wherein each page container has at least one of a widget and an application attached thereto.

12. The non-transitory computer readable medium of claim 11, wherein each child object is associated with only one parent container.

13. The non-transitory computer readable medium of claim 10, wherein the user input is received via a touch screen interface of the computing device.

14. The non-transitory computer readable medium of claim 10, wherein the layout parameters comprise at least one of position, size, font, image location, opacity, scale, and rotation.

15. A computing device comprising a processor in communication with a memory and a display, the processor configured to perform functions comprising:
generating a render tree comprising a plurality of objects each having one or more layout parameters, the plurality of objects including a plurality of page objects each having one or more child objects;
attaching a launcher application to a first container;
attaching a list object to the first container, the list object comprising a plurality of page containers to which the page objects are attached;
traversing the render tree to recursively attach the one or more child objects to respective page containers;
responsive to user input, transforming the list object to a grid object, the grid object comprising transformed page containers having transformed layout parameters, the transformed layout parameters being generated from layout parameters of the page objects in accordance with a grid layout; and
displaying the grid object on the display according to the transformed layout parameters.

16. The computing device of claim 15, wherein each page container has at least one of a widget and an application attached thereto.

17. The computing device of claim 16, wherein each child object is associated with only one parent container.

18. The computing device claim of claim 15, wherein:
the display comprises a touch screen interface; and
the user input is received via the touch screen interface.

19. The computing device of claim 15, wherein the layout parameters comprise at least one of position, size, font, image location, opacity, scale, and rotation.

20. The computing device of claim 15, wherein each child object is associated with only one parent container.
